(19) United States
(12) Patent Application Publication
(10) Pub. No.: US 2021/0014588 A1
(43) Pub. Date: Jan. 14, 2021

(54) Improvements to Support Apparatus

(71) Applicant: Armour Home Electronics Limited, Bishop Stortford Hertfordshire (GB)

(72) Inventors: Kieron Dunk, Hilton Cambridgeshire (GB); Christen Ellis, Great Chishill Hertfordshire (GB)

(21) Appl. No.: 17/041,778

(22) PCT Filed: Mar. 28, 2019
(86) PCT No.: PCT/GB2019/050888

§ 371 Date: Sep. 25, 2020

(30) Foreign Application Priority Data
Mar. 28, 2018 (GB) 1804970.0
Aug. 13, 2018 (GB) 1813164.9

(51) Int. Cl. H04R 1/02; F16M 11/16; F16M 11/22; F16M 11/24

(52) U.S. Cl. CPC H04R 1/026; F16M 11/245; F16M 11/22; F16M 11/16

(57) ABSTRACT

A relatively light and strong stand for mounting an audio speaker thereon. The stand includes a series of relatively rigid elongate struts and a series of flexible elongate members. The elongate members and elongate struts being mutually located such that when the stand is formed, the flexible elongate members are in tension and the elongate struts are in compression. The stand can also include a mounting plate at one end on which the speaker is mourned and at the opposing end of the stand, location means are provided to allow the stand to be located on a support surface. A pulley assembly can be provided to allow the adjustment of the tension on the elongate members and in certain embodiments apertures can be provided on the elongate struts.

The invention to which this application relates is to an improvement in the form of a support apparatus, hereinafter referred to in a non-limiting manner as a stand, for use in supporting an item located thereon at a distance from a support surface. In particular, although not necessarily exclusively, the stand is for use in supporting an item in the form of an audio speaker, at a desired position with respect to a support surface, such as the floor of a room or a surface of an item o inf furniture.

The provision of speaker stands is well-known and it is also well-known that the particular design of stands can vary in terms of the material used to form the same, the particular appearance of the same aesthetically and/or as a result of attempting to provide a particular performance characteristic. Conventionally, there is a general appreciation that the speaker stand should be relatively rigid so as to provide a secure mechanical support for the speaker and also to enhance, or at least not deteriorate, certain performance characteristics for the speaker, such as helping the speaker resist the counter forces generated by the speaker cone or cones moving backward and forward as it pushes against air, and/or to minimise the effect of vibration and energy transfer into the supporting structure of the speaker stand.

One known form of improving performance is to provide the speaker stand with a relatively secure contact with the support surface upon which the same is positioned so as to allow vibrations and/or energy to pass from the speaker via the stand and into the support surface and be dissipated away from the speaker. A common way of achieving this is to provide, at the base of the speaker stand, a plurality of spikes which pass into the support surface.

Although, as stated above, there may be many different designs of speaker stands, it is most commonly the case that all speaker stands include the use of metal or wooden members, typically formed of steel or wood, which are bolted or welded together to form the speaker stand. The speaker stand will also typically comprise the base portion and one or more elongate members depending from the base upwardly to a speaker mount plate and onto which the speaker is placed and/or secured.

The particular distance of the elongate members between the base and the mounting plate can vary for aesthetic appearance requirements, and/or performance requirements.

In whichever format, it is typically the case that the elongate members, mounting plate and base are all permanently connected together either by welding the same or bolting the same together to form a unitary structure. A problem which still exists is that the relatively large surface area of the conventional stands base, mounting plate and upstanding members allow radiation of energy which can adversely affect the audio performance.

An aim of the present invention is to provide a stand of a form which is less bulky, has a reduced surface area and hence provides a reduction in radiating surfaces and to allow an increase in the audio performance of a speaker when in position on the stand, whilst maintaining the structural strength of the speaker.

In a first aspect of the invention, there is provided a stand, the said stand including a series of relatively rigid elongate struts and a series of flexible elongate members, said elongate members and elongate struts mutually located such that when the stand is formed, the flexible elongate members are in tension and the elongate struts are in compression.

Typically the stand is provided to allow an audio speaker to be placed thereon so as to be supported in apposition for use at a location at a spaced distance from a support surface on which the stand is located. In one embodiment the support surface c an be a floor for a room, a surface of an item of furniture or any other surface which provides a secure support for the stand

In one embodiment, the said elongate struts are maintained in a non-direct contact configuration with respect to each other.

In one embodiment, the said elongate members each contact with a first and a second strut.

In one embodiment, each elongate member contacts with a first elongate strut at, or adjacent to, a base end of the same, a second elongate strut at or adjacent to a base end of the same, and the same strut, or a further strut, at or adjacent to the opposing speaker mounting end of the strut.

Typically, one end of the elongate member is held in a fixed position with respect to the first strut and the opposing end of the elongate member is adjustable with respect to its position in relation to the second or further strut at the speaker mounting end of the same. Typically, the ability to adjust the said elongate member is provided so as to allow the said stand to be moved from a storage position to its in use position and/or adjustment of the relative positions of the elongate members and/or tension of the elongate member.

Typically, the independent adjustment of each of the elongate members is possible.

In one embodiment, the adjustment of the respective elongate members is achieved via a pulley assembly which is connected to the elongate struts so as to be retained in a fixed position with respect thereto.

In one embodiment, the pulley assembly is mounted at the speaker mounting end of the stand and, in one embodiment, the speaker may be located directly on the pulley assembly or the struts or alternatively, a mounting plate is positioned intermediate the pulley assembly and the speaker and on which the speaker is located.

In one embodiment the pulley assembly includes a pulley wheel for each of the elongate members and the said pulley wheels are independently adjustable.

In one embodiment, the base ends of the elongate struts are provided with location means such as spikes, which allow the engagement of the speaker stand with a support surface.

In one embodiment, the relationship between the elongate struts and the elongate members are based on the principles of tensegrity.

In one embodiment, the elongate members are lengths of a flexible material such as lengths of stranded cable but it should be appreciated that any form of material which is flexible and has sufficient strength, could be used.

In one embodiment, the said speaker stand is moveable between storage and in use positions and typically, the storage position is used for the transport of the stand from a point of manufacture to a point of assembly whereupon the same can be moved to the in use position.

In one embodiment, the point of assembly is at the location of a retail outlet or at a location at which the stand is to be used, such as in commercial or domestic premises.

In one embodiment, when in the storage position, the struts and flexible elongate members are provided in a semi assembled interconnected condition such that when moved to the in use position, force is applied to the elongate members to tension the same in order to retain the struts, and hence the stand, in the in use position. Alternatively, the storage position can be the provision of a kit of the flexible elongate members, elongate struts, pulley assembly and a mounting plate which are required to be subsequently connected together and assembled to form the speaker stand.

In one embodiment the tension on each of the elongate members is created to a predetermined amount. In one embodiment the kit includes a torque wrench via which the tension can be applied to the flexible elongate members by operating the pulley assembly. In one embodiment the torque wrench is limited to create the predetermined tension and/or indicates when the predetermined tension has been applied.

In one embodiment one or more of the said elongate struts includes at least one aperture formed therein at a location intermediate the ends of the said elongate strut.

In one embodiment, each of the elongate struts includes a plurality of apertures formed therein at spaced intervals.

In one embodiment, the said apertures are formed and located at the same location on each of the elongate struts with respect to the distance from the ends of the elongate members. In one embodiment the location is substantially at the centre of the elongate strut with respect to the length of the same.

In one embodiment the apertures can be selectively positioned with respect to the respective struts.

In one embodiment this may require varying the positions of the apertures for each elongate strut. In one embodiment the selective locations for the apertures on respective elongate struts can lead to asymmetrical positions for the apertures and/or sizes and/or shapes on respective elongate struts.

In one embodiment, the apertures are formed as slots in that they have a longitudinal axis which is longer than width axis.

Typically, the said apertures pass completely through the elongate strut from one side to the opposing side.

In one embodiment, the size and/or shape of the aperture may be varied depending on the dimensions of the elongate strut in which the same is to be formed and/or the particular speaker design which is to be used with the said stand.

The provision of the apertures is aimed at detuning the struts and hence the stand and the provision of the apertures can allow resonance at certain frequencies, when audio signals were passed through the speaker located on the stand, to be eliminated or reduced. Tests using a test tone swept through the speaker were found to result in certain frequencies exciting the elongate struts with, in the tests, the most problematic frequency found to be in the range of ˜65 to 75 Hz depending on the weight of the loudspeaker and tensioning of the elongate members. At this frequency a maximum velocity/displacement was observed around the mid-point of the length of the elongate struts. Although several other modes were observed, these had significantly less amplitude as the tone increased in frequency. It was also observed that the acoustic output directly from the elongate struts is relatively inefficient relative to the direct sound of the loudspeaker, due to the elongate struts having relatively high mass and low radiating area. However, they can couple and impart structural vibration back into the loudspeaker (and support surface such as the floor) which can result in unwanted movement in the loudspeaker structure itself.

In one embodiment the stand includes a plurality of elongate struts held in a mutual configuration by a plurality of elongate members such that the ends of the elongate struts converge towards the end of the stand which is furthest removed from a support surface on which the stand is located for use.

Typically three elongate struts and three elongate members are provided to form the stand.

In a further aspect of the invention, there is provided a speaker stand comprising a plurality of flexible elongate members and relatively rigid elongate struts which are provided in a mutual relationship in accordance with the principles of tensegrity.

In a further aspect of the invention, there is provided a speaker stand assembly, said speaker stand comprising a speaker and a stand including a plurality of elongate struts and a support for the speaker thereon, said support and elongate struts retained in a predetermined configuration by flexible elongate members so as to provide support for the said speaker at a spaced distance from a support surface on which the base end of the elongate struts are located.

In one embodiment the struts of the stand include one or more apertures provided thereon.

In one embodiment the speaker and stand each have located therewith mounting means which match such that when the speaker and stand are brought into an in use position the said mounting means located with each other in a matching arrangement and allow the speaker to be securely located with the said stand. In one embodiment the mounting means include bolts which pass between the respective mounting means on the stand and the speaker.

Specific embodiments of the invention are now described with reference to the accompanying drawings wherein.

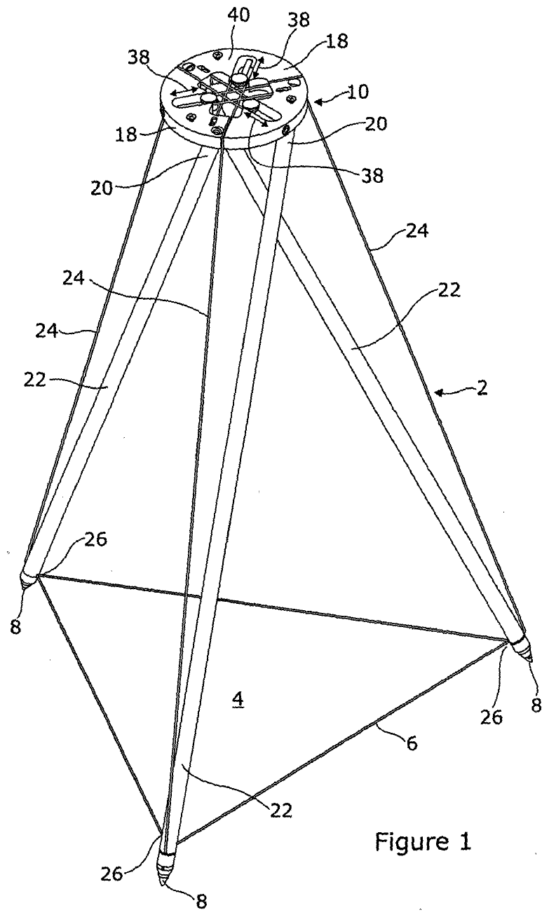

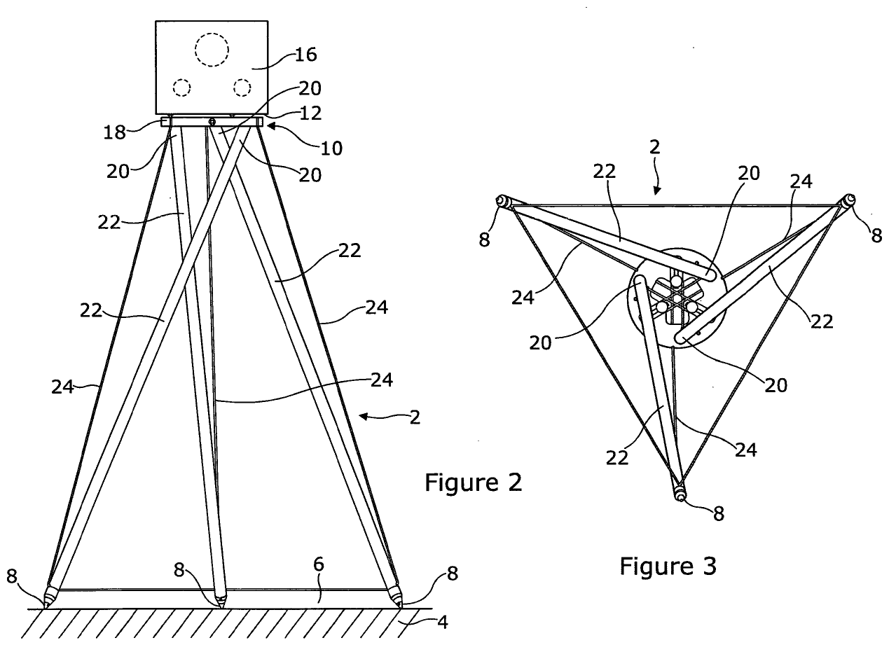

FIGS. 1-5 illustrate views of a speaker stand in accordance with one embodiment of the invention.

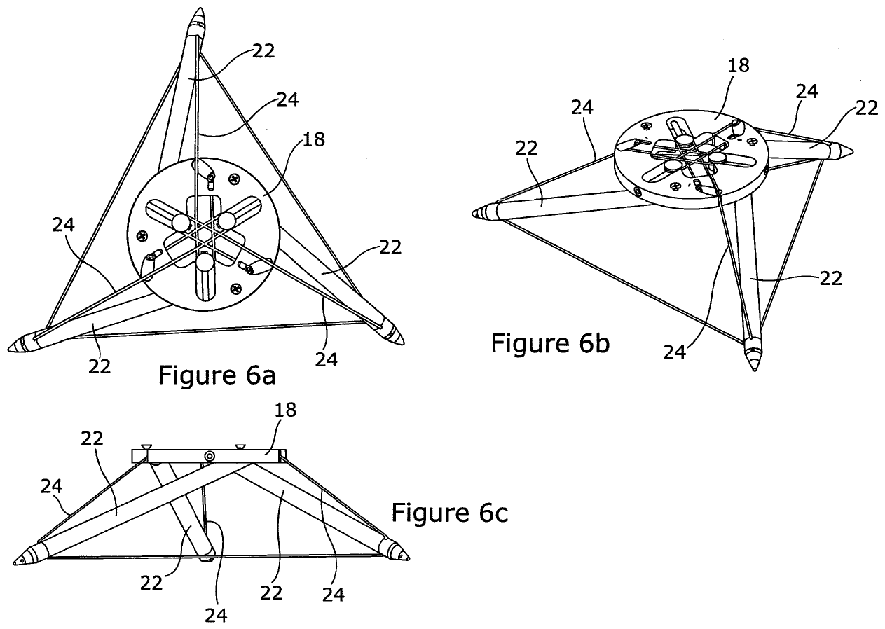

FIGS. 6a to c illustrate an alternative embodiment of a stand according to the invention;

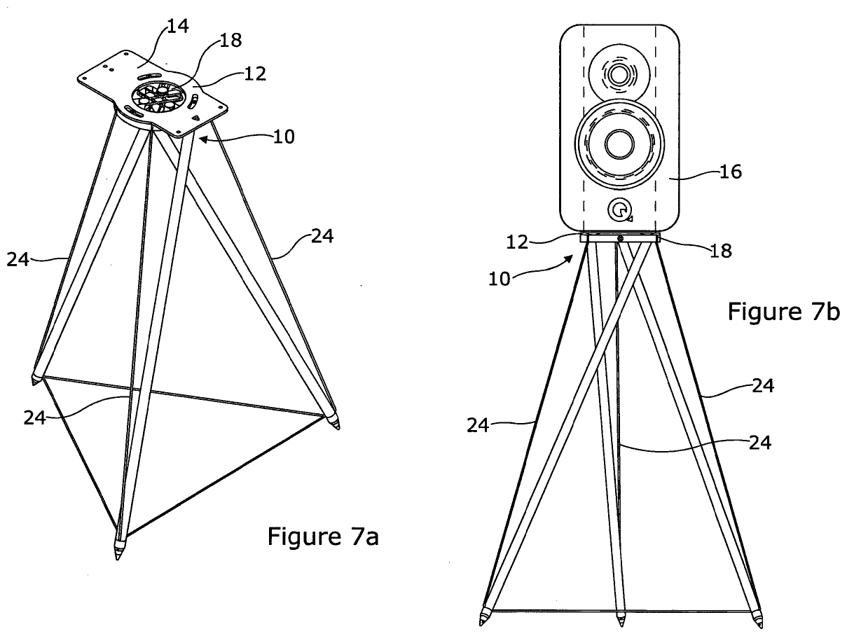

FIGS. 7a illustrates the stand of FIGS. 1-5 with a mounting plate and, in FIG. 7b, with a speaker positioned thereon; and

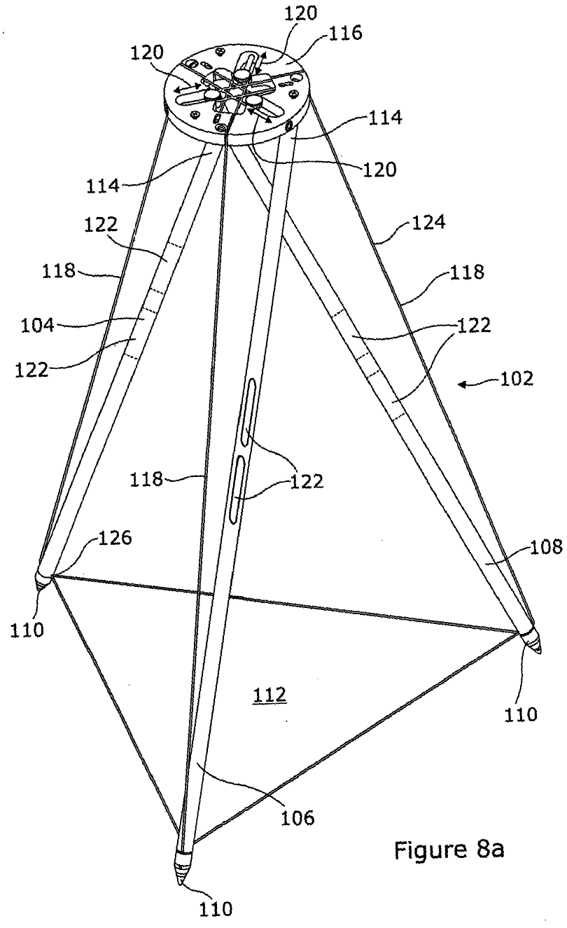

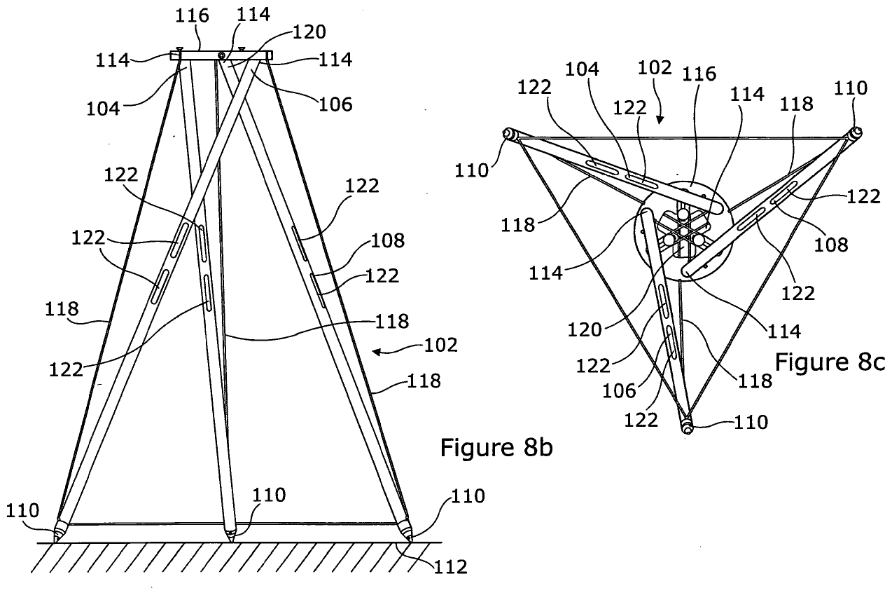

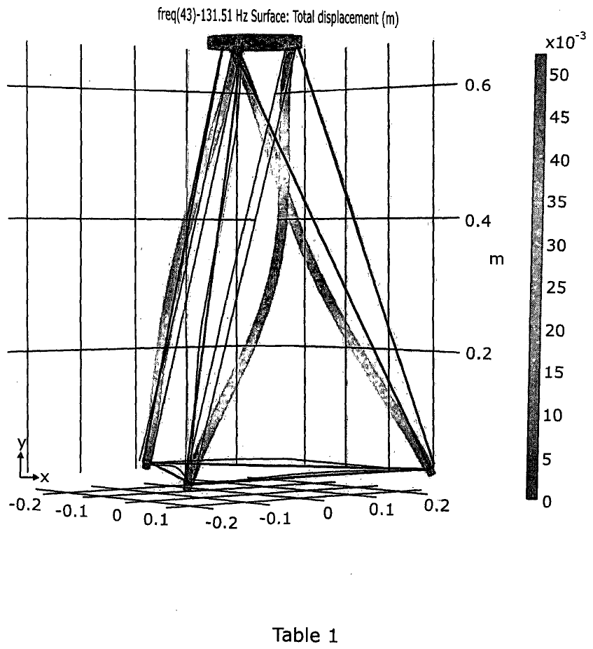

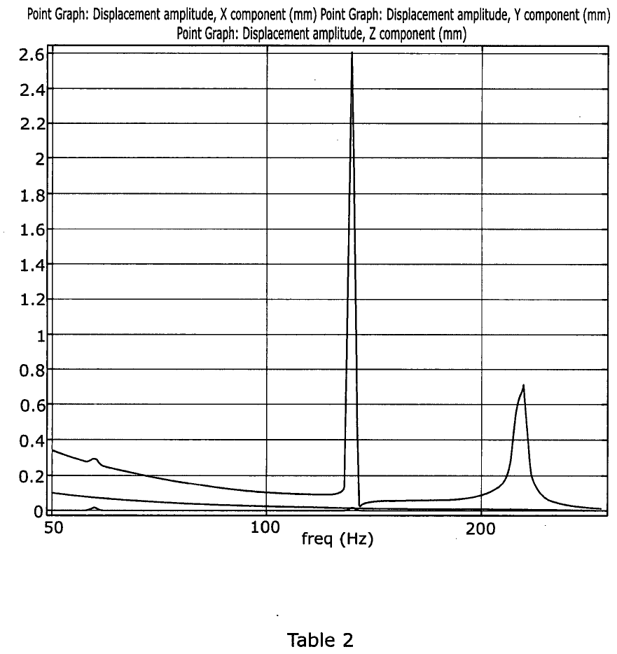

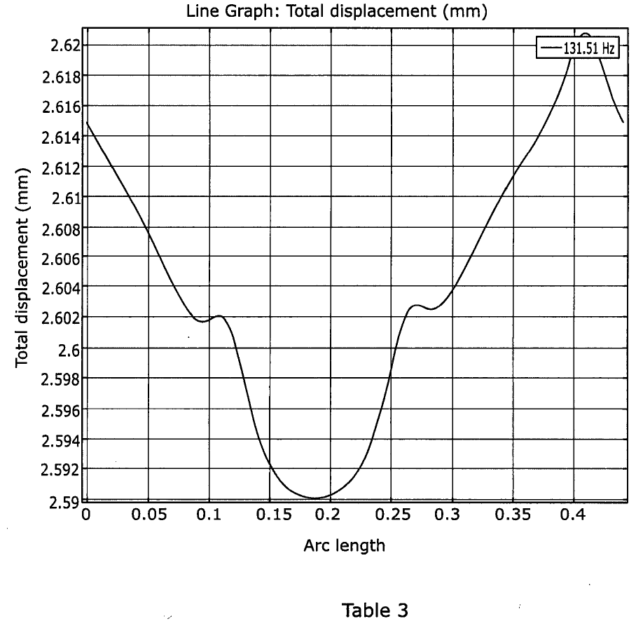

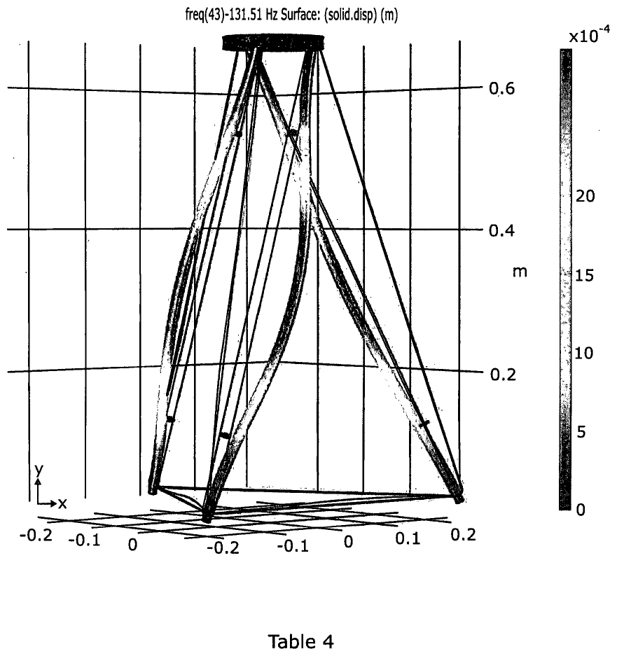

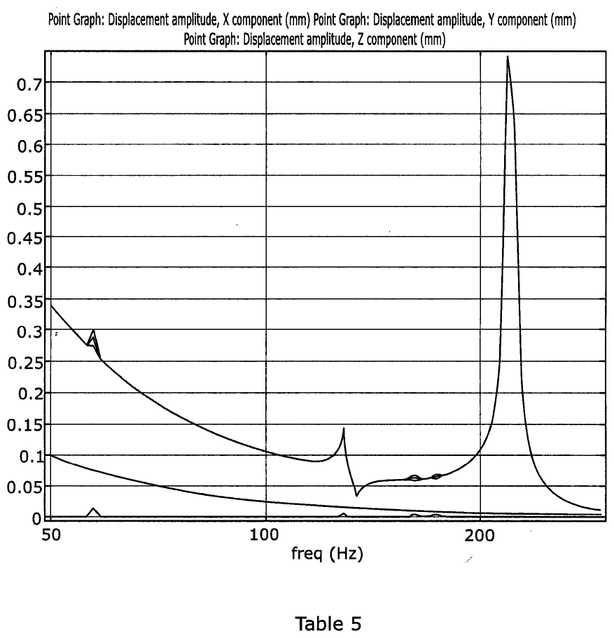

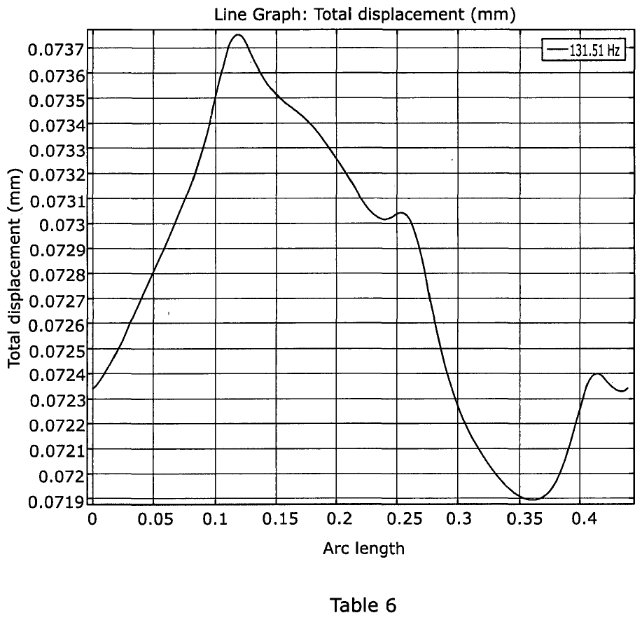

FIGS. 8a-c illustrate further views of a speaker stand formed in accordance with another embodiment of the invention.

Referring now to the FIGS. 1-5, there is provided a speaker stand 2 in accordance with one embodiment of the invention.

The speaker stand is shown in an in use position and is provided with a base 6 for location on a support surface 4. The base of the speaker stand is provided with, and formed by a plurality of spiked feet portions 8 as shown and these act to allow the transfer of vibration to the support surface 4 from the speaker stand whilst, at the same time, providing strong mechanical connection between the speaker stand and the support surface 4. As shown in FIGS. 7a and b a mounting plate 12 is provided at the mounting end 10 of the stand which provides a surface 14 for locating the base of a speaker 16 thereon. Suitable mechanical location means can be provided to allow location of the speaker with the stand or the speaker can be simply self supporting on the mounting plate. In one embodiment the speaker can be provided with, or has attached thereto, mounting means which match with the mounting plate on the stand and hence allow the speaker to be mounted and secured to the mounting plate of the stand.

In this embodiment, the mounting plate 12 is located on and attached to a pulley assembly 18 which, in turn, is located with the ends 20 of a series of relatively rigid elongate struts 22 which depend upwardly from the base 6.

The struts are provided in a configuration such that the same extend between the base 6 and the pulley assembly 18 and converge towards the end at which the speaker mounting plate and/or speaker is to be located, but the struts do not contact each other and, in the in use position, the struts are provided in compression and retained at the respective angular locations as shown.

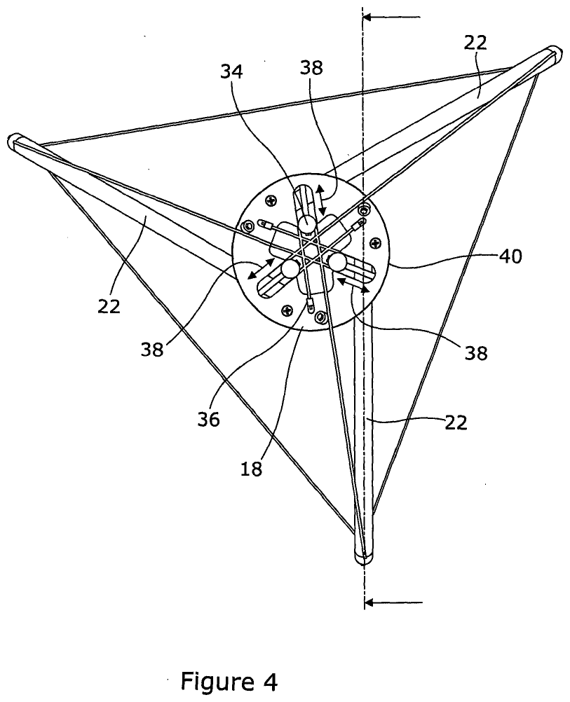

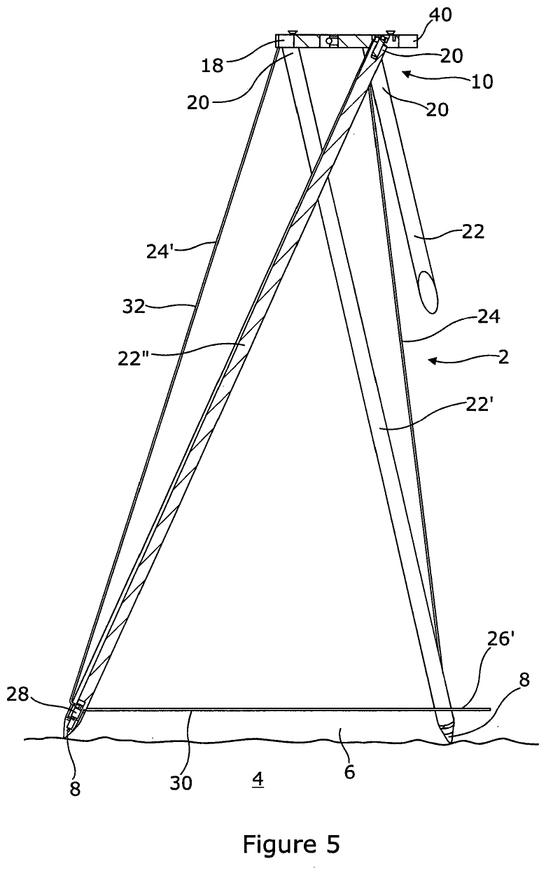

The ability to retain the said struts in compression and at the required angular configuration without contact between the same is achieved by using a series of relatively flexible elongate members which, in this embodiment, are cables 24. Each of the cables extend between the base and the pulley assembly 18 and each of the cables has a first end 26 which in this embodiment, is engaged and retained at the base of one of elongate members 22 then passes to another of the elongate members and then to the pulley assembly, typically via a respective pulley wheel of the pulley assembly. This is illustrated with respect to one of the flexible elongate members 24′ shown in FIG. 5, which is a cross sectional elevation of the stand 2 along line A-A of FIG. 4, and the particular location of the same will now be described. The end 26′ of the elongate member 24′ is engaged and retained in a first strut 22′ and then a portion 30 of the elongate member 24′ passes to an adjacent strut 22″ in a path substantially parallel with the support surface 4 and then passes around a guide 28 in the strut 22″ and a portion 32 of the elongate member 24′ then passes towards the pulley assembly 18 and passes over the top of the said strut 22″ before reaching the pulley assembly 18. The elongate member passes around a pulley wheel 34 in the pulley assembly and then outwardly to retaining means 36 of the pulley assembly which in one form is provided as a cable end with a crimped-on metal cylindrical “button” or retaining formation, which sits in a pocket so that when the elongate member is under tension, it is retained in that location. This configuration is repeated for each respective elongate member 24.

The elongate members 24 are each required to be held in tension so as to maintain the struts 22 in compression and so ensure that the stand 2 is of the required strength and stability. The appropriate level of tension can be applied to the elongate members 24 by linear adjustment of the respective pulley wheel as indicated by arrows 38 with respect to the pulley assembly body 40. When the required tension is reached, then each of the elongate members are retained in that position at the pulley assembly and hence the struts 22 are retained in their respective positions.

FIG. 2 illustrates the manner in which the audio speaker 16 can be located on the stand 2 and typically via the mounting plate as shown in FIG. 7b which shows an alternative form of speaker 16 in position on the stand and so it will be appreciated that the stand can be shaped and dimensioned for particular types of speaker and/or the end user can select to use the stand for a particular form of speaker that they would like to place thereon for their use.

It should be appreciated that the same inventive concept as described with regard to FIGS. 1-5 and FIGS. 7a and b can be used with other designs and FIGS. 6a-c illustrate one such alternative design which is believed to be particularly suited for smaller size speakers and/or stands. In this embodiment, the struts 22, and hence elongate members 24 are shorter in length. This results in a stand which has the same principles and advantages but is of a shorter height.

Referring now to FIGS. 8a-c there is illustrated a further embodiment of the invention in which there is illustrated a speaker stand 102 again including a series of elongate struts 104, 106, 108 which, at the base end 110, are provided to locate on a support surface 112, such as a floor, and, at the opposing ends, or adjacent to the same 114, are located with a speaker mounting plate 116. Again provided are a series of elongate members, in this case in the form of cables 118, which pass between at least two elongate struts at different locations thereon and tensioning means 120 are provided in the form of pulley assembly, located at or adjacent to the mounting plate 116, which allows the said cables, which are located in a fixed position at the first end 110 of an elongate strut, to be tensioned, so that the cables maintain the elongate struts, 104,106,108 and the mounting plate 116 in the required configuration to form the support stand.

Also shown in accordance with this embodiment of the invention is the fact that the elongate struts, in this embodiment each of them, include apertures and in this embodiment, each strut includes two slotted apertures 122. The apertures pass from a first side of the elongate strut 104,106,108 to the opposing side of the elongate strut so as to form a passage through the elongate strut. A particular shape and configuration of the aperture and/or number of apertures on each elongate strut can be selected to suit the particular elongate strut size and shape and/or a particular speaker to be used with the speaker stand as the provision of the apertures is aimed at allowing any distortion of sound which may occur at a particular frequency range when the speaker is located on the stand and is in use, to be reduced or removed as is now described.

The provision of the selective positioning of the apertures allows the resonance characteristics of the strut and hence stand to be moved to a lower frequency, outside the excitation range of the speaker by reducing the bending stiffness of the elongate struts. One or multiple apertures 122 can be used and the apertures are selectively positioned along the elongate struts to optimise performance.

Simulation tests were performed with the aim being to reduce the overall velocity in the legs and minimise the displacement in the loudspeaker structure.

The simulation approximated the materialised embodiment of the stand in accordance with the invention as shown in FIGS. 8a-c and approximations such as rigid fixing constraints are applied at both ends 110, 114 of the elongate struts, to the floor 112 and speaker mounting plate 116. An idealised force was used to generate the excitation, whereas in reality the force reduces in magnitude with frequency due to the mass spring velocity profile of the bass driver of the speaker. The boundary constraints/fixing artificially raised the stiffness in the elongate struts thus shifting the leg mode sets higher in frequency and the latter idealised force exaggerates the displacement. However, the theory applied to resolve the realised stand in practice is valid.

Thus the vibration observed in the stand when coupled to a loudspeaker has been resolved by employing, in this embodiment, two axial apertures in each of the elongate struts of the stand.

1. A stand for a speaker, the said stand including a series of relatively rigid elongate struts and a series of flexible elongate members, said flexible elongate members and elongate struts mutually located such that when the stand is formed, the flexible elongate members are in tension and the elongate struts are in compression.

2. The stand according to claim 1 wherein the said elongate struts are maintained in a non-direct contact configuration with respect to each other and said flexible elongate members each contact with a first and a second elongate strut.

3. (canceled)

4. The stand according to claim 2 wherein each flexible elongate member contacts with the first elongate strut at, or adjacent to, a first end of the same, the second elongate strut at or adjacent to a first end of the same and the same, or a further strut at, or adjacent to, an opposing, second end of the strut.

5. The stand according to claim 4 wherein one end of the flexible elongate member is held in a fixed position with respect to the first elongate strut and an opposing end of the flexible elongate member is adjustable with respect to its position in relation to the second strut or the further strut.

6. The stand according to claim 5 wherein adjustment of the said flexible elongate members allows the said stand to be moved between a storage and an in-use position and/or adjustment of the relative position, and/or tension, of the flexible elongate members.

7. (canceled)

8. The stand according to claim 5 wherein the adjustment of respective flexible elongate members is achieved via a pulley assembly which is connected to the elongate struts so as to be retained in a fixed position with respect thereto,

9. The stand according to claim 8 wherein the pulley assembly is mounted at/or adjacent to an end of the stand at which a. speaker is to be mounted.

10. (canceled)

11. The stand according to claim 9 wherein the speaker is located on a mounting plate positioned intermediate the pulley assembly and the speaker.

12. (canceled)

13. The stand according to claim 1 wherein a relationship between the elongate struts and the flexible elongate members is based on principles of tensegrity, and the flexible elongate members are lengths of flexible material.

14. (canceled)

15. (canceled)

16. The stand according to claim 6 wherein in the storage position the elongate struts and flexible elongate members are provided in a semi-assembled condition such that when moved to the in-use position, force is applied to the flexible elongate members to tension the same and to move and retain the elongate struts, and hence the speaker stand, in the in-use position.

17. (canceled)

18. The stand according to claim 1 wherein tension in the flexible elongate members is applied to a predetermined value.

19. The stand according to claim 1 wherein one or more of the said elongate struts includes at least one aperture formed therein at a location intermediate ends of the said elongate strut.

20. The stand according to claim 19 wherein one or more of the elongate struts includes a plurality of apertures formed therein at spaced intervals.

21. (canceled)

22. The stand according to claim 19 wherein the said location is substantially at a centre of the elongate strut with respect to a length of the same.

23. (canceled)

24. (canceled)

25. (canceled)

26. The stand according to claim 19 wherein the one or more apertures are formed as slots with a longitudinal axis which is longer than the width axis.

27. (canceled)

28. The stand according to claim 1 wherein the stand includes a plurality of elongate struts held in a mutual configuration by a plurality of elongate members such that ends of the elongate struts converge towards an end of the stand which is furthest removed from a support surface on which the stand is located for use.

29. The stand according to claim 28 wherein three elongate struts and three elongate members are provided to form the stand.

30. A speaker stand comprising a plurality of flexible elongate members and relatively rigid elongate struts which are provided in a mutual relationship in accordance with the principles of tensegrity.

31. A speaker stand assembly, said speaker stand assembly comprising:
a speaker; and
a stand including a plurality of elongate struts and a support for the speaker thereon, said support and elongate struts retained in a predetermined configuration by flexible elongate members so as to provide support for the said speaker at a spaced distance from a support surface on which a base end of each of the plurality of elongate struts is located.

32. An assembly according to claim 31 wherein one, or more of the elongate struts includes one or more apertures formed therein.

33. (canceled)

34. (canceled)
